(19) United States
(12) Patent Application Publication
(10) Pub. No.: US 2023/0348816 A1
(43) Pub. Date: Nov. 2, 2023

(54) COMPOSITIONS COMPRISING A NONIONIC ADDITIVE AND A NONIONIC RINSE SURFACTANT AND THE USE THEREOF FOR REDUCING DEPOSITION OF FAT ON A SURFACE

(71) Applicant: BASF SE, Ludwigshafen am Rhein (DE)

(72) Inventors: Frederic BAUER, Ludwigshafen (DE); Heike WEBER, Ludwigshafen (DE); Juergen TROPSCH, Ludwigshafen (DE)

(21) Appl. No.: 17/918,795

(22) PCT Filed: Mar. 22, 2021
(86) PCT No.: PCT/EP2021/057308

§ 371 Date: Oct. 13, 2022

(30) Foreign Application Priority Data
Jul. 2, 2020 (EP) 20183691.3

(51) Int. Cl. C11D 1/825; C11D 11/00; C11D 17/04

(52) U.S. Cl. CPC C11D 1/8255; C11D 11/0029; C11D 11/0035; C11D 11/0052; C11D 17/044; C11D 1/721

(57) ABSTRACT

Described herein is a method for reducing deposition of fat on a surface from a fat containing aqueous liquid where the fat containing aqueous liquid includes a cleaning compositionincluding at least one additive of general formula (I)

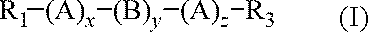

and at least one rinse surfactant. Also described herein is a method of using the cleaning composition for reducing accumulation of fat on a surface. Further, described herein is a unit dose article including the cleaning composition.

### FIELD OF THE INVENTION

The presently claimed invention is directed to a method for reducing deposition of fat on a surface from a fat containing aqueous liquid wherein the fat containing aqueous liquid comprises a cleaning composition comprising at least one additive of the general formula (I) and at least one rinse surfactant. The presently claimed invention further relates to the use of the cleaning composition for reducing accumulation of fat on a surface. The presently claimed invention also relates to a unit dose article comprising the cleaning composition of the present invention.

### BACKGROUND OF THE INVENTION

Detergent formulations, especially detergent formulations for automatic dishwashing, have to meet various requirements. When being used in automatic dishwashing, such detergent formulations need to enable a complete cleaning of china, polymer, metal, clay, and glassware and to remove all sorts of soil, like fat, proteins, starch, dyes, and more. The soil needs to be dispersed in water during the cleaning and the water removal process, and the various soils should not deposit in the dishwashing machine in case of automatic dishwashing. Finally, during the drying process, the cleaned good should exhibit a good drying behavior, without spotting.

Mixed hydroxy ethers (“HME’s”) are particularly efficient non-ionic surfactants for rinsing, especially when combined with certain polymers, see, e. g., WO 2008/095563. However, it has been found that in many cases fatty residues accumulate on the parts of the pump and circulation protecting filter systems such as particle filters or sieves, of automatic dishwashing machines, for example Miele type G 1222 GSL, Miele type G 1223 SC GSL2, Miele type G 696-2SC, Miele type G 681 SC plus, Miele type G 641 SC and Bosch type SGS 57 M82, Bosch type Active Water SMS65T25EU and Bosch type Super Silence SMS65M12EU. Such residues usually contain surfactant and fat which has been removed from the dishware. The deposition of residues is disadvantageous because such filters or sieves remain dirty even after the dishwash cleaning operation. Furthermore, such fatty residues may become smelly in case the machine is not in use for some time, and they may even become a hygiene hazard. Mixed hydroxy ethers are particularly efficient non-ionic surfactants, however, especially the use of mixed hydroxy ethers in formulations for automatic dishwashers can lead to rather high amounts of fat-based residues in the filters or sieves.

It was therefore the objective of the present invention to provide environmentally friendly cleaning compositions which prevent or reduce the deposition of fat residues and also provide excellent cleaning properties such as spotting and filming.

### SUMMARY OF THE INVENTION

Surprisingly, it was found that if certain additives are added to the cleaning composition they significantly reduce the creaming effect which is seen as the root cause of fat deposition, and thus, they prevent fat agglomeration and deposition.

Therefore, in an aspect, the presently claimed invention is directed to a method for reducing deposition of fat on a surface from a fat containing aqueous liquid wherein the fat containing aqueous liquid comprises a cleaning composition comprising
(i) at least one additive of the general formula (I)

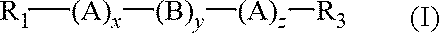

wherein
   R₁ is independently selected from linear or branched, substituted or unsubstituted C₁ to C₂₂ alkyl
   A is CH₂—CH₂—O
   B is CH₂—CHR₂—O, wherein R₂ is selected from H and linear or branched, unsubstituted C₁ to C₈ alkyl
   R₃ is selected from H and linear or branched, substituted or unsubstituted C₁ to C₂₂ alkyl
   x is an integer in the range of 1 to 100
   y is an integer in the range of 0 to 35
   z is an integer in the range of 0 to 35; and
(ii) at least one rinse surfactant which has a melting point in the range of 25° C. to 50° C. and cloud point in the range of 35° C. to 70° C., determined according to DIN EN 1890:1999.

In another aspect, the presently claimed invention is directed to use of the cleaning composition as defined above, for reducing accumulation of fat on a surface.

In yet another aspect, the presently claimed invention is directed to a unit dose article comprising the cleaning composition as defined above.

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

If hereinafter a group is defined to comprise at least a certain number of embodiments, this is meant to also encompass a group which preferably consists of these embodiments only.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” or “in another embodiment” in various places throughout this specification are not necessarily all referring to the same embodiment but may. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

In an aspect, the presently claimed invention is directed to a method for reducing deposition of fat on a surface from a fat containing aqueous liquid wherein the fat containing aqueous liquid comprises a cleaning composition comprising
(i) at least one additive of the general formula (I)

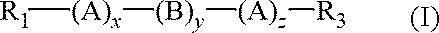

wherein
   R₁ is independently selected from linear or branched, substituted or unsubstituted C₁ to C₂₂ alkyl
   A is CH₂—CH₂—O
   B is CH₂—CHR₂—O, wherein R₂ is selected from H and linear or branched, unsubstituted C₁ to C₈ alkyl
   R₃ is selected from H and linear or branched, substituted or unsubstituted C₁ to C₂₂ alkyl
   x is an integer in the range of 1 to 100
   y is an integer in the range of 0 to 35
   z is an integer in the range of 0 to 35; and
(ii) at least one rinse surfactant which has a melting point in the range of 25° C. to 50° C. and cloud point in the range of 35° C. to 70° C., determined according to DIN EN 1890:1999.

### Additive of the General Formula (I)

The at least one additive of the presently claimed invention is the compound of the general formula (I),

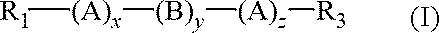

wherein
R₁ is independently selected from linear or branched, substituted or unsubstituted C₁ to C₂₂ alkyl,
A is CH₂—CH₂—O,
B is CH₂—CHR₂—O, wherein R₂ is selected from H and linear or branched, unsubstituted C₁ to C₈ alkyl,
R₃ is selected from H and linear or branched, substituted or unsubstituted C₁ to C₂₂ alkyl,
x is an integer in the range of 1 to 100,
y is an integer in the range of 0 to 35, and
z is an integer in the range of 0 to 35.

Within the context of the present invention, the term “alkyl”, as used herein, refers to acyclic saturated aliphatic residues, including linear or branched alkyl residues. Furthermore, the alkyl residue is preferably unsubstituted and includes as in the case of C₁-C₂₂ alkyl 1 to 22 carbon atoms.

As used herein, “branched” denotes a chain of atoms with one or more side chains attached to it. Branching occurs by the replacement of a substituent, e.g., a hydrogen atom, with a covalently bonded aliphatic moiety.

Representative examples of linear and branched, unsubstituted C₁-C₂₂ alkyl include, but are not limited to methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, n-heneicosyl, n-docosyl, isopropyl, isobutyl, isopentyl, isohexyl, isoheptyl, isooctyl, isononyl, isodecyl, isoundecyl, isododecyl, isotridecyl, isotetradecyl, isopentadecyl, isohexadecyl, isoheptadecyl, isooctadecyl, isononadecyl, isoeicosyl, isoheneicosyl, isodocosyl, 2-propyl heptyl, 2-ethyl hexyl and t-butyl.

In an embodiment, R₁ is selected from linear or branched, unsubstituted C₁-C₂₂ alkyl, x is an integer in the range of 2 to 100, y is 0, z is 0 and R₃ is H.

In another embodiment, R₁ is selected from linear or branched, unsubstituted C₁₀-C₂₂ alkyl, x is an integer in the range of 5 to 90, y is 0, z is 0 and R₃ is H.

In yet another embodiment, R₁ is selected from linear or branched, unsubstituted C₁₂-C₂₀ alkyl, x is an integer in the range of 10 to 90, y is 0, z is 0 and R₃ is H.

In yet another embodiment, R₁ is selected from linear or branched, unsubstituted C₁₄-C₁₈ alkyl, x is an integer in the range of 20 to 90, y is 0, z is 0 and R₃ is H.

In yet another embodiment, R₁ is selected from linear or branched, unsubstituted C₁₆-C₁₈ alkyl, x is an integer in the range of 30 to 90, y is 0, z is 0 and R₃ is H.

In an embodiment, the at least one additive of the general formula (I) has a hydrophilic-lipophilic balance (HLB) value in the range of 10 to 19.

The HLB value represents the hydrophilic-lipophilic balance of the molecule. The lower the HLB value the more hydrophobic the material is, and vice versa. The HLB values can be calculated according to the method given in Griffin, J.Soc. Cosmetic Chemists, 5 (1954) 249-256.

Griffith’s method for nonionic surfactants as described in 1954 is as follows:

HLB = 20 × Mₕ/M where
Mₕ is the molecular mass of the hydrophilic portion of the molecule; and
M is the molecular mass of the whole molecule. Only the EO part in the surfactants is regarded as hydrophilic, all other parts contribute only to the whole molecule.

The amount of at least one additive is in the range of 0.1 % to 1 % by weight, based on the total weight of the composition.

### Rinse Surfactant

In an embodiment, the presently claimed invention comprises at least one rinse surfactant.

In an embodiment, the at least one rinse surfactant has a melting point in the range of 25° C. to 50° C. and cloud point in the range of 35° C. to 70° C., determined according to DIN EN 1890:1999.

The melting point of a compound is a temperature at which the compound changes from solid to liquid state. In the present case, clear melting point is determined. Clear melting point of a compound is the temperature at which it changes completely to a clear liquid.

The clear melting point is determined with a Reichert-Jung microscope Type 302101, using a Reichert Jung heating system Type 651501 and heating plate V40W80 R6416 with a testoterm 7000 Pt 100 temperature sensing device. While operating with polarized light. For the optical magnification to detect the clear melting point visually a Bausch & Lomb WF10x/18 binocular and 60/- objective is used in the microscope. The temperature is noted when the sample changes from translucent solid to a clear liquid.

Cloud point is the temperature above which an aqueous solution of a surfactant becomes turbid. The cloud point is determined according to standard method DIN EN 1890:1999.

In an embodiment, the at least one rinse surfactant is a compound of general formula (II)

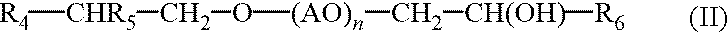

wherein
R₄ is selected from linear or branched, substituted or unsubstituted C₂-C₄-alkyl,
R₅ is linear or branched, substituted or unsubstituted alkyl bearing two carbon atoms more than R₄,
n is an integer in the range of 10 to 35,
AO is selected from identical or different, CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O, and CH₂—CH(C₂H₅)—O, and
R₆ is selected from linear or branched, substituted or unsubstituted C₆-C₁₈-alkyl.

In an embodiment, R₄ is selected from the group consisting of ethyl, n-propyl, iso-propyl, n-butyl, sec.-butyl and iso-butyl.

In a preferred embodiment, R₄ is selected from the group consisting of ethyl, n-propyl and iso-propyl.

In an embodiment, R₅ is selected from the group consisting of n-butyl, iso-butyl, n-pentyl, iso-pentyl, 3-methylpentyl, n-hexyl and iso-hexyl.

In an embodiment, n is in the range of from 10 to 35,

In a preferred embodiment, n is in the range of 20 to 30.

In a more preferred embodiment, n is in the range of 22 to 30.

In the context of the present invention, the variable n is to be understood an average number, such average referring to the number average.

In an embodiment, AO is identical or different and selected from CH₂—CH₂—O, (CH₂)₃—O, (CH₂)₄—O and CH₂CH(CH₃)—O

In a more preferred embodiment, AO is CH₂—CH₂—O.

In one embodiment, (AO)ₙ is (CH₂CH₂O)ₙ₁, n₁ being selected from 10 to 35.

In an embodiment, identical or different, preferably selected from CH₂—CH₂—O, (CH₂)₃—O, (CH₂)₄—O, CH₂CH(CH₃)—O, CH(CH₃)—CH₂—O— and CH₂CH(n—C₃H₇)—O. Preferred example of AO is CH₂—CH₂—O (“EO”).

In one embodiment of the present invention, AO is (PO)ₘ—(EO)ₙ₋ₘ and m is in the range of from 0.2 to 2, m being an average value, preferably the number average. In a preferred embodiment, AO is PO—(EO)ₙ₋₁.

In one embodiment of the present invention, (AO)ₙ is selected from —(CH₂CH₂O)ₙ₂—(CH₂CH(CH₃)—O)ₙ₃ and —(CH₂CH₂O)ₙ₂—(CH(CH₃)CH₂—O)ₙ₃, n₂ and n₃ being identical or different and selected from 1 to 30, the sum of n₂ and n₃ being in the range of from 10 to 35.

In one embodiment of the present invention, (AO)ₙ is selected from —(CH₂CH₂O)₁₄, n₄ = being in the range of from 10 to 35, all AO being EO, R₄ is n—C₃H₇ and R₅ is n—C₅H₁₁.

In another embodiment of the present invention, (AO)ₙ is selected from —(CH₂CH₂O)ₙ₄, n₄ = being in the range of from 10 to 35, all AO being EO, R₄ is iso—C₃H₇ and R₅ is pentyl with at least one methyl branching.

In the context of the present invention, n or n₁ or n₂ and n₃ or n₄ are to be understood as average values, the number average being preferred. Therefore, each n or n₁ or n₂ or n₃ or n₄ - if applicable - can refer to a fraction although a specific molecule can only carry a whole number of alkylene oxide units.

In an embodiment, R₆ is selected from the group consisting of n-hexyl, iso-hexyl, n-heptyl, isoheptyl, n-octyl, iso-octyl, n-nonyl, iso-nonyl, n-decyl, n-dodecyl, n-tetradecyl, n-hexadecyl and n-octadecyl.

In a preferred embodiment, R₆ is selected from the group consisting of n-hexyl, n-octyl, n-decyl, n-dodecyl, n-tetradecyl, n-hexadecyl and n-octadecyl.

In a preferred embodiment, R₆ is selected from the group consisting of n-hexyl, n-octyl, n-decyl and n-dodecyl.

In another preferred embodiment, R₆ is selected from the group consisting of n-decyl and n-dodecyl.

In one embodiment of the present invention, R₅ is a mixture of n—C₅H₁₁ and pentyl with one branching, for example 2-methylbutyl or 3-methylbutyl, and R₄ is n-propyl.

In a preferred embodiment, R₄ is n-propyl and R₅ is a mixture of n—C₅H₁₁ and C₅H₁₁ with one branching in a molar range of from 99:1 to 4:1.

In another embodiment, the at least one rinse surfactant is a compound of general formula (III)

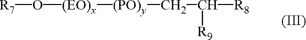

wherein
R₇ and R₈ is independently selected from linear or branched, substituted or unsubstituted C₆-C₂₀-alkyl,
R₉ is selected from H and OH,
EO is CH₂—CH₂—O,
PO is selected from CH(CH₃)—CH₂—O and CH₂—CH(CH₃)—O,
x is an integer in the range of 10 to 50, and
y is an integer in the range of 0 to 10.

In an embodiment, R₇ and R₈ are independently selected from linear or branched, unsubstituted C₆-C₂₀-alkyl,

In an embodiment, R₇ and R₈ are independently selected from n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, isohexyl, isoheptyl, isooctyl, isononyl, isodecyl, isoundecyl, isododecyl, isotridecyl, isotetradecyl, isopentadecyl, isohexadecyl, isoheptadecyl, isooctadecyl, isononadecyl, isoeicosyl, 2-ethyl hexyl, 2-propyl heptyl and mixtures thereof.

In another embodiment, R₇ is selected from n-octyl, n-nonyl, n-decyl, n-undecyl, n-tridecyl, isononyl, isoundecyl, isotridecyl, 2-ethyl hexyl, 2-propyl heptyl and mixtures thereof.

In an embodiment, R₇ is selected from n-octyl, n-nonyl, n-decyl, n-undecyl, n-dodecyl, n-tridecyl, n-tetradecyl, n-pentadecyl, n-hexadecyl, n-heptadecyl, n-octadecyl, isooctyl, isononyl, isodecyl, isoundecyl, isododecyl, isotridecyl, isotetradecyl, isopentadecyl, isohexadecyl, isoheptadecyl, isooctadecyl, 2-ethyl hexyl, 2-propyl heptyl and mixtures thereof.

In an embodiment, R₈ is selected from n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, isohexyl, isoheptyl, isooctyl, isononyl, isodecyl, isoundecyl, isododecyl, isotridecyl, isotetradecyl, isopentadecyl, isohexadecyl, isoheptadecyl, isooctadecyl, isononadecyl, isoeicosyl, 2-ethyl hexyl, 2-propyl heptyl and mixtures thereof.

In another embodiment, R₈ is selected from n-hexyl, n-octyl, n-decyl, n-tridecyl, isohexyl, isooctyl, isodecyl, isotridecyl, 2-ethyl hexyl, 2-propyl heptyl and mixtures thereof.

In an embodiment, the amount of the at least one rinse surfactant is in the range of 0.5 % to 10.0 % by weight, based on the total weight of the composition.

In another embodiment, the amount of the at least one rinse surfactant is in the range of 1.0 % to 8.0 % by weight, based on the total weight of the composition.

In an embodiment, the molar ratio of (i) the at least one additive of the general formula (I), and (ii) the at least one rinse surfactant is in the range of 0.02:1 to 1:1.

### Adjunct Component

The cleaning composition of the presently claimed invention optionally comprises at least on adjunct component. The at least one adjunct component is selected from chelating agents, enzymes, builders, cobuilders, alkali metal carriers, bleaching agents, bleach catalysts, bleach activators, dyes, perfumes, corrosion inhibitors, anti-redeposition agents and fillers.

### Chelating Agents

The cleaning composition according to the invention may include a chelating/sequestering agent such as an aminocarboxylic acid, a condensed phosphate, a phosphonate and a polyacrylate. In general, a chelating agent is a molecule capable of coordinating (i.e., binding) the metal ions commonly found in natural water to prevent the metal ions from interfering with the action of the other detersive ingredients of the dishwashing composition. Useful aminocarboxylic acids include, for example, n-hydroxyethyliminodiacetic acid, nitrilotriacetic acid (NTA), ethylenediaminetetraacetic acid (EDTA), N-hydroxyethyl ethylenediaminetriacetic acid (HEDTA), diethylenetriamine pentaacetic acid (DTPA), methylglycinediacetic acid (MGDA) and glutamic acid diacetic acid (GLDA). Examples of condensed phosphates are sodium and potassium orthophosphate, sodium and potassium pyrophosphate, sodium tripolyphosphate and sodium hexametaphosphate.

Aminocarboxylic acid diacetates are compounds with at least one amino group that is carboxyalkylated with two CH₂—COOH groups. Aminosuccinates are compounds with at least one nitrogen atom per molecule that bears a CH(COOH)CH₂COOH group. In each case, the respective alkali metal salts are preferred over their respective free acids.

In an embodiment, the cleaning compositions comprises aminocarboxylic acid diacetates selected from methylglycine diacetic acid (MGDA), and glutamic acid diacetic acid (GLDA).

In an embodiment, MGDA and GLDA are comprised in the form of alkali metal salts, for example in the form of potassium salts or sodium salts or as mixed sodium-potassium salts.

Preferred alkali metal salts of MGDA are compounds according to the general formula (III a)

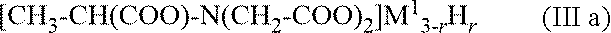

wherein
M¹ is selected from alkali metal cations, same or different, preferably potassium and especially sodium, and
wherein r is in the range of from zero to 0.5.

Preferred alkali metal salts of GLDA are compounds according to the general formula (III a)

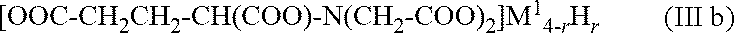

Wherein r is in the range of from zero to 1.5, and M¹ is defined as above.

It is to be understood that r is an average number.

Compounds according to general formula (III a) and (III b) may be comprised as racemic mixture or as pure enantiomers, especially as L-enantiomers, or as non-racemic mixtures of enantiomers, for example with an enantiomeric excess in the range of from 20 to 85%, the respective L-enantiomer being the predominant enantiomer.

Particularly preferred are racemic mixtures of the trisodium salt of MGDA, racemic mixture or non-racemic mixtures of enantiomers wherein the L-enantiomer prevails, with an enantiomeric excess in the range of from 20 to 85%. Another particularly preferred embodiment is the tetrasodium salt of GLDA as non-racemic mixtures of enantiomers wherein the L-enantiomer prevails, with an enantiomeric excess in the range of from 20 to 99.5%. Another particularly preferred embodiment are mixtures of the trisodium and the tetrasodium salts of GLDA each as non-racemic mixtures of enantiomers wherein the L-enantiomers prevail, with enantiomeric excesses in the range of from 20 to 99.5%.

Compounds according to general formula (III a) and (III b) may contain impurities resulting from their synthesis. In the case of MGDA and its alkali metal salts, such impurities may include propionic acid, lactic acid, alanine, nitrilotriacetic acid (NTA) or the like and their respective alkali metal salts, and complexes of Mg²⁺, Ca²⁺, Fe(II+) and Fe(III+). Such impurities are usually present in minor amounts. “Minor amounts” in this context refer to a total of 0.1 to 5% by weight, referring to alkali metal salt of chelating agent (B), preferably up to 2.5% by weight. In the context of the present invention, such minor amounts are neglected when determining the composition of the respective detergent composition according to the present invention.

The chelating agent may be citric acid or an alkali metal salt of citric acid.

### Enzymes

The cleaning compositions of the presently claimed invention may comprise one or more enzymes. Enzymes are often used to aid the removal of stains. In most cases the enzymes react with the soiling and break it down into particles that have increased water solubility or are better dispersible in the washing liquid. The enzymes that can be used in dishwashing compositions include, but are not limited to, hydrolases, proteases, amylases, lipases, cellulases, mannanase, peroxidase, oxidase, xylanase, pullulanase, glucanase, pectinase, cutinase, hemicellulases, glucoamylases, phospholipases, esterases, keratanases, reductases, phenoloxidases, lipoxygenases, ligninases, tannases, pentosanases, malanases, arabinosidases, hyaluronidase, chondroitinase, lactases or mixtures thereof.

In one embodiment, the cleaning compositions of the presently claimed invention may comprise, for example, up to 5% by weight of enzyme, preference being given to 0.1 to 3% by weight. Said enzyme may be stabilized, for example with the sodium salt of at least one C₁-C₃-carboxylic acid or C₄-C₁₀-dicarboxylic acid. Preferred are formates, acetates, adipates, and succinates.

### Builders

The cleaning compositions of the presently claimed invention may comprise one or more builders, selected from organic and inorganic builders. Examples of suitable inorganic builders are sodium sulfate or sodium carbonate or silicates, in particular sodium disilicate and sodium metasilicate, zeolites, sheet silicates, in particular those of the formula α—Na₂Si₂O₅, β—Na₂Si₂O₅, and δ—Na₂Si₂O₅, also fatty acid sulfonates, α-hydroxypropionic acid, alkali metal malonates, fatty acid sulfonates, alkyl and alkenyl disuccinates, tartaric acid diacetate, tartaric acid monoacetate, oxidized starch, and polymeric builders, for example polycarboxylates and polyaspartic acid.

Examples of organic builders are especially polymers and copolymers. In one embodiment of the present invention, organic builders are selected from polycarboxylates, for example alkali metal salts of (meth)acrylic acid homopolymers or (meth)acrylic acid copolymers.

Suitable comonomers are monoethylenically unsaturated dicarboxylic acids such as maleic acid, fumaric acid, maleic anhydride, itaconic acid and citraconic acid. A suitable polymer is in particular polyacrylic acid, which preferably has an average molecular weight M_{w} in the range from 2000 to 40000 g/mol, preferably 2000 to 10000 g/mol, in particular 3000 to 8000 g/mol. Also, of suitability are copolymeric polycarboxylates, in particular those of acrylic acid with methacrylic acid and of acrylic acid or methacrylic acid with maleic acid and/or fumaric acid, and in the same range of molecular weight.

It is also possible to use copolymers of at least one monomer from the group consisting of monoethylenically unsaturated C₃-C₁₀-mono- or C₄-C₁₀-dicarboxylic acids or anhydrides thereof, such as maleic acid, maleic anhydride, acrylic acid, methacrylic acid, fumaric acid, itaconic acid and citraconic acid, with at least one hydrophilic or hydrophobic monomer as listed below.

Suitable hydrophobic monomers are, for example, isobutene, diisobutene, butene, pentene, hexene and styrene, olefins with 10 or more carbon atoms or mixtures thereof, such as, for example, 1-decene, 1-dodecene, 1-tetradecene, 1-hexadecene, 1-octadecene, 1-eicosene, 1-docosene, 1-tetracosene and 1-hexacosene, C₂₂-α-olefin, a mixture of C₂₀-C₂₄-α-olefins and polyisobutene having on average 12 to 100 carbon atoms per molecule.

Suitable hydrophilic monomers are monomers with sulfonate or phosphonate groups, and also nonionic monomers with hydroxyl function or alkylene oxide groups. By way of example, mention may be made of: allyl alcohol, isoprenol, methoxypolyethylene glycol (meth)acrylate, methoxypolypropylene glycol (meth)acrylate, methoxypolybutylene glycol (meth)acrylate, methoxypoly(propylene oxide-co-ethylene oxide) (meth)acrylate, ethoxypolyethylene glycol (meth)acrylate, ethoxypolypropylene glycol (meth)acrylate, ethoxypolybutylene glycol (meth)acrylate and ethoxypoly(propylene oxide-co-ethylene oxide) (meth)acrylate. Polyalkylene glycols here may comprise 3 to 50, in particular 5 to 40 and especially 10 to 30 alkylene oxide units per molecule.

Particularly preferred sulfonic-acid-group-containing monomers here are 1-acrylamido-1-propanesulfonic acid, 2-acrylamido-2-propanesulfonic acid, 2-acrylamido-2-methylpropanesulfonic acid, 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and salts of said acids, such as sodium, potassium or ammonium salts thereof.

Particularly preferred phosphonate-group-containing monomers are vinylphosphonic acid and its salts.

A further example of builders is carboxymethyl inulin.

Moreover, amphoteric polymers can also be used as builders.

Cleaning compositions may comprise, for example, in the range from in total 10 to 70% by weight, preferably up to 50% by weight, of builder.

### Cobuilders

The cleaning compositions may comprise cobuilders. Examples of cobuilders are phosphonates, for example hydroxyalkanephosphonates and aminoalkanephosphonates. Hydroxyalkanephosphonates such as 1-hydroxyethane-1,1-diphosphonate (HEDP) is preferably used as the sodium salt, the disodium salt being neutral and the tetrasodium salt being alkaline (pH 9). Suitable aminoalkanephosphonates are preferably ethylenediaminetetramethylenephosphonate (EDTMP), diethylenetriaminepentamethylenephosphonate (DTPMP) and also higher homologs thereof. They are preferably used in the form of the neutrally reacting sodium salts, e.g. as the hexasodium salt of EDTMP or as the hepta- and octasodium salts of DTPMP.

### Alkali Metal Carriers

The cleaning composition according to the present invention may comprise one or more alkali metal carriers. Alkali metal carriers provide, for example, a pH of at least 9, if an alkaline pH is desired. For example, alkali metal carbonates, alkali metal hydrogen carbonates, alkali metal hydroxides and alkali metal metasilicates are suitable alkali metal carriers.

### Bleaching Agents

The cleaning composition of the present invention may optionally comprise one or more bleaching agents. The bleaching agents can be used in a detergent composition either alone or in combination with a bleach activator and/or a bleach catalyst. The function of the bleaching agent is the removal of bleachable stains and to achieve an antibacterial effect on the load and inside of the dishwashing machine. Bleaching agents commonly used as a sole bleaching ingredient in dishwashing composition react with the soil. When an inorganic oxygen based bleaching agent is used in combination with a bleach activator it does react with the bleach activator. One of the reaction products provides the actual performance. When an inorganic oxygen based bleaching agent is used in combination with a bleach catalyst, the catalyst catalyses the oxidation reaction with the substrate. The oxidized bleach catalyst provides the actual bleach performance. A bleach activator can optionally be present.

Bleaching agents may be selected from chlorine bleach and peroxide bleach, and peroxide bleach may be selected from inorganic peroxide bleach and organic peroxide bleach. Preferred are inorganic peroxide bleaches, selected from alkali metal percarbonate such as sodium percarbonate, alkali metal perborate and alkali metal persulfate.

Examples of organic peroxide bleaches are organic percarboxylic acids, especially organic percarboxylic acids.

In the cleaning compositions, alkali metal percarbonates, especially sodium percarbonates, are preferably used in coated form. Such coatings may be of organic or inorganic nature. Examples are glycerol, sodium sulfate, silicate, sodium carbonate, and combinations of at least two of the foregoing, for example combinations of sodium carbonate and sodium sulfate.

Suitable chlorine-containing bleaches are, for example, 1,3-dichloro-5,5-dimethylhydantoin, N-chlorosulfamide, chloramine T, chloramine B, sodium hypochlorite, calcium hypochlorite, magnesium hypochlorite, potassium hypochlorite, potassium dichloroisocyanurate and sodium dichloroisocyanurate.

The cleaning compositions may comprise, for example, in the range from 3 to 10% by weight of chlorine-containing bleach.

### Bleach Catalysts

A bleaching catalyst can be used besides to or instead of a bleach activator. Bleach catalysts can be selected from bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Complexes including these metals can interact with inorganic and organic peroxygen compounds to form reactive intermediates. The use of a bleach catalyst can result in achieving the desired bleaching performance at an even lower temperature than needed for bleach activators. Bleaching catalysts include, but are not limited to a complex of manganese (IV) with 1,4,7-trimethyl-1,4,7-triazacyclononane (MnMe₃TACN), tris[2-(salicylideneamino)ethyl]amine manganese(III), siderophore-metal complexes, metal complexes containing ligands of 1,4,7-triazacyclononan (TACN), manganese-protein complexes.

### Bleach Activators

The cleaning compositions may comprise one or more bleach activators. Bleaching agents that can be used in detergent compositions include, but are not limited to, tetraacetylethylenediamine (TAED), tetraacetylhexylenediamine, sodium nonanoyloxybenzene sulfonate (NOBS), acetyl caprolactone, N-methyl morpholinium acetonitrile salts (“MMA salts”), and salts thereof, sodium 4-(2-decanoyl oxyethoxycarbonyloxy) benzenesulfonate (DECOBS), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts).

### Dyes

The cleaning composition of the present invention may optionally comprise one or more dyes. The dye is used to colour the dishwashing composition. This might render the product more attractive to the consumer. Dyes that can be used in dishwashing composition include, but are not limited to, Nylosan yellow N-7GL, Sanolin brilliant flavine 8GZ, Sanolin yellow BG, Vitasyn quinoline yellow 70, Vitasyn tartrazine X90, Puricolor yellow AYE23, Basacid yellow 232, Vibracolor yellow AYE17, Simacid Eosine Y, Puricolor red ARE27, Puricolor red ARE14, Vibracolor red ARE18, Vibracolor red ARE52, Vibracolor red SRE3, Basacid red 316, Ponceau SX, Iragon blue DBL86, Sanolin blue EHRL, Sanolin turquoise blue FBL, Basacid blue 750, Iragon blue ABL80, Vitasyn blue AE90, Basacid blue755, Vitasyn patentblue V 8501 and Vibracolor green AGR25.

### Perfumes

The cleaning composition may optionally comprise one or more perfumes. Perfume is added to the cleaning composition to improve the sensorial properties of the product or of the dishwasher after cleaning. The perfume can be added to the detergent as a liquid, paste or as a co-granulate with a carrier material for the perfume. To improve the stability of the perfume it can be used in an encapsulated form or as a complex like for example a perfume-cyclodextrin complex. Also perfumes that have a deodorizing effect can be applied. Such perfumes or raw materials encapsulate malodors by binding to their sulphur groups.

### Corrosion Inhibitors

The cleaning compositions may comprise one or more corrosion inhibitors. In the present case, this is to be understood as including those compounds that inhibit the corrosion of metal. Examples of suitable corrosion inhibitors are triazoles, in particular benzotriazoles, bisbenzotriazoles, aminotriazoles, alkylaminotriazoles, also phenol derivatives such as, for example, hydroquinone, pyrocatechol, hydroxyhydroquinone, gallic acid, phloroglucinol or pyrogallol.

In one embodiment of the present invention, cleaning compositions comprise in total in the range from 0.1 to 1.5% by weight of corrosion inhibitor.

### Anti-Redeposition Agents

The cleaning composition may optionally comprise one or more anti-redeposition agents. The main function of anti-redeposition agents is the aid to prevent the soil from redepositing on the washing substrate when a washing liquor provides insufficient soil anti-redeposition capacity. Anti-redeposition agent(s) can provide their effect by becoming adsorbed irreversibly or reversibly to the soil particles or to the substrate, thereby the soil becomes better dispersed in the washing liquor or the substrate is occupied with anti-redeposition agent(s) on those places the soil could redeposit. The anti-redeposition agent(s) that are known to be used in dishwashing compositions include, but are not limited to, carboxymethyl cellulose, polyester-PEG co-polymer, polyvinyl pyrrolidone based polymers.

### Fillers

An inert particulate filler material which is water-soluble may also be present in the cleaning compositions in powder form. This material should not precipitate calcium or magnesium ions at the filler use level. Suitable for this purpose are organic or inorganic compounds. Organic fillers include sucrose esters and urea. Representative inorganic fillers include sodium sulfate, sodium chloride and potassium chloride.

### Additional Surfactants

The cleaning composition do not contain additional surfactant other than rinse surfactant. However, if desired, the cleaning composition may optionally comprise additional surfactants for secondary performance such as, but not limited to, improved degreasing, optimized foaming profile.

Examples of such additional surfactants other than rinse surfactants are especially non-ionic surfactants other than the rinse surfactants.

Preferred non-ionic surfactants are alkoxylated alcohols, di- and multiblock copolymers of ethylene oxide and propylene oxide and reaction products of sorbitan with ethylene oxide or propylene oxide, alkyl polyglycosides (APG), hydroxyalkyl mixed ethers and amine oxides.

Preferred examples of alkoxylated alcohols and alkoxylated fatty alcohols are, for example, compounds of the general formula (IV)

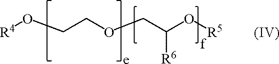

in which the variables are defined as follows:
R⁴ is selected from C₈-C₂₂-alkyl, branched or linear, for example n—CₛH₁₇, n—C₁₀H₂₁, n—C₁₂H₂₅, n—C₁₄H₂₉, n—C₁₆H₃₃ or n—C₁₈H₃₇,
R⁵ is selected from C₁-C₁₀-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,
R⁶ is identical or different and selected from hydrogen and linear C₁-C₁₀-alkyl, preferably in each case identical and ethyl and particularly preferably hydrogen or methyl,

The variables e and f are in the range from zero to 300, where the sum of e and f is at least one, preferably in the range of from 3 to 50. Preferably, e is in the range from 1 to 100 and f is in the range from 0 to 30.

In one embodiment, compounds of the general formula (IV) may be block copolymers or random copolymers, preference being given to block copolymers.

Other preferred examples of alkoxylated alcohols are, for example, compounds of the general formula (V)

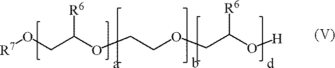

in which the variables are defined as follows:
R⁶ is identical or different and selected from hydrogen and linear C₁-C₄-alkyl, preferably identical in each case and ethyl and particularly preferably hydrogen or methyl,
R⁷ is selected from C₆-C₂₀-alkyl, branched or linear, in particular n—C₈H₁₇, n—C₁₀H₂₁, n—C₁₂H₂₅, n—C₁₃H₂₇, n—C₁₅H₃₁, n—C₁₄H₂₉, n—C₁₆H₃₃, n—C₁₈H₃₇, and combinations of at least two of the foregoing,
a is a number in the range from zero to 10, preferably from 1 to 6,
b is a number in the range from 1 to 80, preferably from 4 to 20,
d is a number in the range from zero to 50, preferably 4 to 25.

The sum a + b + d is preferably in the range of from 5 to 100, even more preferably in the range of from 9 to 50.

The variables m and n are in the range from zero to 300, where the sum of n and m is at least one, preferably in the range of from 5 to 50. Preferably, m is in the range from 1 to 100 and n is in the range from 0 to 30.

Another class of non-ionic surfactants are hydroxyl group bearing compounds other than compound (I). Preferred examples of hydroxyl group bearing compounds are compounds of the general formula (VI)

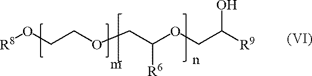

in which the variables are defined as follows:
R⁶ is identical or different and selected from hydrogen and linear C₁-C₁₀-alkyl, preferably in each case identical and ethyl and particularly preferably hydrogen or methyl,
R⁸ is selected from C₈-C₂₂-alkyl, branched or preferably linear, for example iso—C₁₁H₂₃, iso—C₁₃H₂₇, n—C₈H₁₇, n—C₁₀H₂₁, n—C₁₂H₂₅, n—C₁₄H₂₉, n—C₁₆H₃₃ or n—C₁₈H₃₇,
R⁹ is selected from C₁-C₁₈-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl, isodecyl, n-dodecyl, n-tetradecyl, n-hexadecyl, and n-octadecyl.

The variables m and n are in the range from zero to 300, where the sum of n and m is at least one, preferably in the range of from 5 to 50. Preferably, n is in the range from 1 to 100 and m is in the range from 0 to 30.

In a special version, hydroxyl group bearing compounds are compounds of the general formula (VI a)

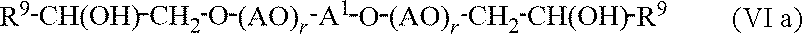

wherein
R⁹ are same or different and defined as above,
r same or different and selected from 6 to 50, preferably 12 to 25. In compounds according to general formula (I b), it is preferred that both r assume the same value.
A¹ is selected from C₂-C₁₀-alkylene, straight chain or branched, for example —CH₂—CH₂—, —CH₂—CH(CH₃)—, —CH₂—CH(CH₂CH₃)—, —CH₂—CH(n—C₃H₇)—,—CH₂—CH(n—c₄H₉), —CH₂—CH(n—C₅H₁₁)—, —CH₂—CH(n—C₆H₁₃)—, —CH₂—CH(n—C₈H₁₇)—, —CH(CH₃)—CH(CH₃)—, —(CH₂)₃—, —(CH₂)₄—, —(CH₂)₅—, —(CH₂)₆—, —(CH₂)₈—, —(CH₂)₁₀—, —C(CH₃)₂—, —CH₂—C(CH₃)₂—CH₂—, and —CH₂—[C(CH₃)₂]₂—CH₂—.

Preferred residues A¹ are —CH₂—CH₂—, CH₂—CH(CH₃)—, —CH₂—CH(CH₂CH₃)—, —CH₂—CH(n—C₃H₇)—, —CH₂—CH(n—C₄H₉)—, —CH₂—CH(n—C₆H₁₃)—, and —(CH₂)₄—.

Compounds of the general formula (IV), (V) and (VI) and especially (VI a) may be block copolymers or random copolymers, preference being given to block copolymers.

Further suitable nonionic surfactants are selected from di- and multiblock copolymers, composed of ethylene oxide and propylene oxide. Further suitable nonionic surfactants are selected from ethoxylated or propoxylated sorbitan esters. Amine oxides or alkyl polyglycosides, especially linear C₄-C₁₆-alkyl polyglucosides and branched C₈-C₁₄-alkyl polyglycosides such as compounds of general average formula (VII) are likewise suitable.

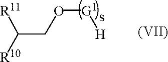

wherein:
R¹⁰ is C₁-C₄-alkyl, in particular ethyl, n-propyl or isopropyl, or hydrogen,
R¹¹ is —(CH₂)₂—R¹⁰, or n-C₇-C₁₂-alkyl,
G¹ is selected from monosaccharides with 4 to 6 carbon atoms, especially from glucose and xylose,
s in the range of from 1.1 to 4, s being an average number,

Further examples of non-ionic surfactants are compounds of general formula (VIII) and (IX)

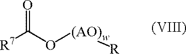

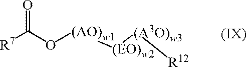

R⁷ and AO are defined as above,
R¹² selected from C₈-C₁₈-alkyl, branched or linear.
A³O is selected from propylene oxide and butylene oxide,
w is a number in the range of from 15 to 70, preferably 30 to 50,
w1 and w3 are numbers in the range of from 1 to 5, and
w2 is a number in the range of from 13 to 35.

An overview of suitable further nonionic surfactants can be found in EP-A 0 851 023 and in DE-A 198 19 187.

Mixtures of two or more different nonionic surfactants selected from the foregoing may also be present.

The cleaning compositions may comprise one or more anionic or zwitterionic surfactants.

Examples of amphoteric surfactants are those that bear a positive and a negative charge in the same molecule under use conditions. Preferred examples of amphoteric surfactants are so-called betaine-surfactants. Many examples of betaine-surfactants bear one quaternized nitrogen atom and one carboxylic acid group per molecule. A particularly preferred example of amphoteric surfactants is cocamidopropyl betaine (lauramidopropyl betaine).

Examples of amine oxide surfactants are compounds of the general formula (X)

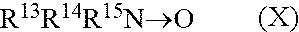

wherein R¹³, R¹⁴, and R¹⁵ are selected independently from each other from aliphatic, cycloaliphatic or C₂-C₄-alkylene C₁₀-C₂₀-alkylamido moieties. Preferably, R¹³ is selected from C₈-C₂₀-alkyl or C₂-C₄-alkylene C₁₀-C₂₀-alkylamido and R¹⁵ and R¹⁴ are both methyl.

A particularly preferred example is lauryl dimethyl aminoxide, sometimes also called lauramine oxide. A further particularly preferred example is cocamidylpropyl dimethylaminoxide, sometimes also called cocamidopropylamine oxide.

Examples of suitable anionic surfactants are alkali metal and ammonium salts of C₈-C₁₈-alkyl sulfates, of C₈-C₁₈-fatty alcohol polyether sulfates, of sulfuric acid half-esters of ethoxylated C₄-C₁₂-alkylphenols (ethoxylation: 1 to 50 mol of ethylene oxide/mol), C₁₂-C₁₈ sulfo fatty acid alkyl esters, for example of C₁₂-C₁₈ sulfo fatty acid methyl esters, furthermore of C₁₂-C₁₈-alkylsulfonic acids and of C₁₀-C₁₈-alkylarylsulfonic acids. Preference is given to the alkali metal salts of the aforementioned compounds, particularly preferably the sodium salts.

Further examples for suitable anionic surfactants are soaps, for example the sodium or potassium salts of stearic acid, oleic acid, palmitic acid, ether carboxylates, and alkylether phosphates.

In one embodiment of the present invention, the cleaning compositions may contain 0.1 to 60 % by weight of at least one surfactant, selected from anionic surfactants, amphoteric surfactants and amine oxide surfactants.

In a preferred embodiment, the cleaning compositions do not contain any anionic surfactant.

### Antifoam Agents

The cleaning compositions may comprise one or more antifoams, selected for example from silicone oils and paraffin oils.

In one embodiment of the present invention, the cleaning compositions comprise in total in the range from 0.05 to 0.5% by weight of antifoam.

### Zinc Salts

In one embodiment of the present invention, the cleaning compositions, especially when used as automatic dishwashing detergents, may comprise at least one zinc salt. Zinc salts may be selected from water-soluble and water-insoluble zinc salts. In this connection, within the context of the present invention, water-insoluble is used to refer to those zinc salts which, in distilled water at 25° C., have a solubility of 0.1 g/l or less. Zinc salts which have a higher solubility in water are accordingly referred to within the context of the present invention as water-soluble zinc salts.

In one embodiment of the present invention, zinc salt is selected from zinc benzoate, zinc gluconate, zinc lactate, zinc formate, ZnCl₂, ZnSO₄, zinc acetate, zinc citrate, Zn(NO₃)₂, Zn(CH₃SO₃)₂ and zinc gallate, preferably ZnCl₂, ZnSO₄, zinc acetate, zinc citrate, Zn(NO₃)₂, Zn(CH₃SO₃)₂ and zinc gallate.

In another embodiment of the present invention, zinc salt is selected from ZnO, ZnO·aq, Zn(OH)₂ and ZnCO₃. Preference is given to ZnO·aq.

In one embodiment of the present invention, zinc salt is selected from zinc oxides with an average particle diameter (weight-average) in the range from 10 nm to 100 µm.

The cation in zinc salt can be present in complexed form, for example complexed with ammonia ligands or water ligands, and in particular be present in hydrated form. To simplify the notation, within the context of the present invention, ligands are generally omitted if they are water ligands.

Depending on how the pH of mixture according to the invention is adjusted, zinc salt can change. Thus, it is for example possible to use zinc acetate or ZnCl₂ for preparing formulation according to the invention, but this converts at a pH of 8 or 9 in an aqueous environment to ZnO, Zn(OH)₂ or ZnO·aq, which can be present in non-complexed or in complexed form.

Zinc salt may be present in those inventive automatic dishwashing formulations which are solid at room temperature are preferably present in the form of particles which have for example an average diameter (number-average) in the range from 10 nm to 100 µm, preferably 100 nm to 5 µm, determined for example by X-ray scattering.

Zinc salt may be present in those detergent compositions for home care applications that are liquid at room temperature in dissolved or in solid or in colloidal form.

In one embodiment of the present invention, the cleaning composition may comprise in total in the range from 0.05 to 0.4% by weight of zinc salt, based in each case on the solids content of the composition in question.

Here, the fraction of zinc salt is given as zinc or zinc ions. From this, it is possible to calculate the counterion fraction.

### Polyalkyleneimine

In one embodiment of the present invention, the cleaning composition contain polyalkylenimine, for example polypropylenimine or polyethylenimine. Polyalkylenimine may be substituted, for example with CH₂COOH groups or with polyalkylenoxide chains, or non-substituted. In one embodiment of the present invention, 60 to 80 mole-% of the primary and secondary amine functions of polyalkylenimines are substituted with CH₂COOH groups or with ethylene oxide or propylene oxide. Particularly preferred are non-substituted polyethylenimine with an average molecular weight M_{w} in a range of from 500 to 20,000 g/mol, determined advantageously by gel permeation chromatography (GPC) in 1.5 % by weight aqueous formic acid as eluent and cross-linked poly-hydroxyethylmethacrylate as stationary phase. In other embodiments, polyethoxylated polyethylenimines are preferred, with an average molecular weight M_{w} in a range of from 2,500 to 50,000 g/mol, determined advantageously by gel permeation chromatography (GPC) in 1.5 % by weight aqueous formic acid as eluent and cross-linked poly-hydroxyethylmethacrylate as stationary phase. In other embodiments, polyethoxylated polypropylenimines are preferred, with an average molecular weight M_{w} in a range of from 2,500 to 50,000 g/mol, determined advantageously by gel permeation chromatography (GPC) in 1.5 % by weight aqueous formic acid as eluent and cross-linked poly-hydroxyethylmethacrylate as stationary phase.

Polyethylenimines and polypropylenimines, non-substituted or substituted as above, may applied in small amounts, for example 0.01 to 2% by weight, referring to the total solids content of the respective inventive automatic dishwashing formulation.

The cleaning composition of the presently claimed invention may comprise more than one additive. For example, the cleaning composition of the present invention may comprise as additive, a surfactant, a builder and a combination of the foregoing.

In one embodiment of the present invention, the cleaning composition of the present invention are free from heavy metals apart from zinc compounds. Within the context of the present, this may be understood as meaning that the cleaning compositions are free from those heavy metal compounds which do not act as bleach catalysts, in particular of compounds of iron and of bismuth. Within the context of the present invention, “free from” in connection with heavy metal compounds is to be understood as meaning that the content of heavy metal compounds that do not act as bleach catalysts is in sum in the range from 0 to 100 ppm, determined by the leach method and based on the solids content. Preferably, detergent compositions according to the invention has, apart from zinc, a heavy metal content below 0.05 ppm, based on the solids content of the formulation in question. The fraction of zinc is thus not included.

Within the context of the present invention, “heavy metals” are defined to be any metal with a specific density of at least 6 g/cm³ with the exception of zinc. In particular, the heavy metals are metals such as bismuth, iron, copper, lead, tin, nickel, cadmium and chromium.

Preferably, the cleaning composition comprise no measurable fractions of bismuth compounds, i.e. for example less than 1 ppm.

In one embodiment of the present invention, the cleaning compositions comprise, in addition to additives, one or more further ingredient such as organic solvents, buffers, disintegrants for tabs, and/or acids such as methylsulfonic acid.

### Method

In an embodiment, the presently claimed invention is directed to a method for reducing deposition of fat on a surface from a fat containing aqueous liquid.

In an embodiment, the surface is a metal surface, plastic surface, glass surface, porcelain surface or ceramic surface.

In an embodiment, the surface is located inside a dishwasher.

In another embodiment, the surface is the interior surfaces of dishwasher itself, for example, but not restricted to, parts of the pump and circulation protecting filter systems such as particle filters or sieves, side walls, spray arms and dish baskets.

In an embodiment, the surface is located inside the dishwasher and is in fluid connection with the dishwasher washing chamber.

In another embodiment, the surface is facing the dishwasher washing chamber.

In an embodiment, the presently claimed invention is directed to the method for reducing deposition of fat in a dishwasher from a fat containing aqueous liquid, wherein the fat containing aqueous liquid comprises a cleaning composition comprising at least one additive of the general formula (I) as defined herein above and at least one rinse surfactant as defined herein above.

In an embodiment, the dishwasher is an automatic dishwasher.

In an embodiment, the presently claimed invention is directed to the method for reducing deposition of fat in an automatic dishwasher from a fat containing aqueous liquid, comprising at least one or more of the steps selected from
(a) arranging the soiled dishware in the dishwasher,
(b) adding the cleaning composition as described herein above, to the dosing chamber of the automatic dishwasher,
(c) selecting and initiating a wash program of the automatic dishwasher,
(d) obtaining during wash operation a fat containing aqueous liquid; and
(e) rinsing the dishware of step (d) in the final wash operation step.

In an embodiment, the method further comprises step (f) of drying the dishware.

The operations and programs of a typical automatic dishwasher are known to a person skilled in the art.

The cleaning composition is dosed into the interior of an automatic dishwasher during its run through a dishwashing program, before the start of the main rinse cycle or in the course of the main rinse cycle. The dosing, i.e., the addition of the cleaning composition according to the invention to the interior of the automatic dishwasher may take place manually, but the cleaning composition is preferably dosed into the interior of the dishwasher by means of the dosing chamber of the dishwasher.

Dishware in the context of the present invention shall not only refer to plates from china but also to any kitchenware from china, metal, glass, clay or polymer, such as - but not limited to - cups, bowls and plates from china, flatware, drinking glasses such as wine glasses, champagne flutes, beer glasses and the like, and plastic kitchenware, furthermore pots, frying pans.

Dishware is provided in soiled form, among other soiled with fatty residue, also referred to as fat, that may stem from food itself or - for example in the case of frying pans - fat that stems from cooking or frying or baking food. The term “fat” may also include butter, margarine, lard, beef tallow, palm fat, coconut fat or oil, especially oil like sunflower oil, olive oil or other oil that is used for cooking purposes and mixtures thereof.

Said fatty residue may be the sole soiling of dishware to be cleaned according to the inventive cleaning process. In another embodiment of the present invention, dishware to be cleaned according to inventive cleaning process may be soiled with a combination of fat and at least one substance other than fat, for example pigment(s), protein, carbohydrates such as starch or sugar, caramel, furthermore lecithin, or dyestuff(s).

By the term ‘fat containing aqueous liquid’ it is meant that the fat from the dishware is removed in the process of washing in the automatic dishwasher and gets mixed with water. The cleaning composition of the presently claimed invention reduces the deposition of this fat containing aqueous liquid on the surfaces of dishwasher and hence fatty residues do not accumulate in the filter, walls or sieves of automatic dishwashing machines.

The cleaning program is being carried out at temperatures in the range of from 15 to 70° C. Said temperature refers to the temperature of the water being used in the different process steps during a cleaning program in the dishwasher.

The cleaning program is being carried out using water. The amount of water is influenced by the type of machine used and by the choice of the program.

In an aspect, the presently claimed invention is directed to use of the cleaning composition as defined above, for reducing accumulation of fat on a surface.

In an embodiment, the presently claimed invention is directed to the use of the cleaning composition as defined herein above, for reducing accumulation of fat, wherein the surface is a metal surface, plastic surface, glass surface, porcelain surface or ceramic surface.

In an embodiment, the surface is located inside a dishwasher.

In another embodiment, the surface is located inside the dishwasher and is in fluid connection with the dishwasher washing chamber.

In an embodiment, the surface is part of the inner surface of the dishwasher washing chamber.

In an embodiment, the presently claimed invention is directed to the use of the cleaning composition as defined herein above, wherein the cleaning composition is stored and/or employed for use in the form of powder, gel, tablet or liquid form.

In an embodiment, the presently claimed invention is directed to the use of the cleaning composition as defined herein above in an automatic dishwasher.

In another aspect, the presently claimed invention is directed to a unit dose article comprising the cleaning composition as defined above.

In a preferred embodiment, the unit dose article comprises single or multiple compartments.

In another preferred embodiment, the unit dose article is preferably a water-soluble unit dose article. The water-soluble unit dose article may be in the form of a tablet, capsule, sachet or a pouch. Preferably, the water-soluble unit dose article is a pouch.

The water-soluble unit dose article comprises at least one internal compartment surrounded by a water-soluble film. The at least one compartment comprises the cleaning composition. The water-soluble film is sealed such that the composition does not leak out of the compartment during storage. However, upon addition of the water-soluble unit dose article to water, the water-soluble film dissolves and releases the contents of the internal compartment into the dishwasher. The unit dose article is manufactured such that the water-soluble film completely surrounds the cleaning composition and in doing so defines the compartment in which the composition resides. The unit dose article may comprise two films, or even three films. A first film may be shaped to comprise an open compartment into which the cleaning composition is added. A second film may then be laid over the first film in such an orientation as to close the opening of the compartment. The first and second films may then be sealed together along a seal region.

The water-soluble unit dose article may comprise two, or even three, or even four internal compartments, preferably wherein the compartments are arranged side-by-side, in a superposed orientation or a mixture thereof. The compartments may be arranged such that two side-by-side compartments are superposed onto a third compartment wherein the third compartment is larger than the first and/or second compartments. Alternatively, the compartments may be arranged such that three side-by-side compartments are superposed onto a fourth compartment, wherein the fourth compartment is larger than the first and/or second and/or third compartments.

The unit dose article may preferably be transparent, translucent or opaque. The water-soluble film may preferably be transparent, translucent or opaque.

Preferably, the water-soluble film has a thickness of between 20 microns and 100 microns.

Preferably, the film has a water-solubility of at least 50%, preferably at least 75% or even at least 95%.

The film materials are preferably polymeric materials. Preferred polymers, copolymers or derivatives thereof suitable for use as pouch material are selected from the group of polyvinyl alcohols, polyvinyl pyrrolidone, polyalkylene oxides, acrylamide, acrylic acid, cellulose, cellulose ethers, cellulose esters, cellulose am-ides, polyvinyl acetates, polycarboxylic acids and salts, polyaminoacids or peptides, polyamides, polyacrylamide, copolymers of maleic/acrylic acids, polysaccharides including starch and gelatin, natural gums such as xanthum and carragum. More preferred polymers are selected from the group of polyacrylates and water-soluble acrylate copolymers, methylcellulose, carboxymethylcellulose sodium, dextrin, ethyl-cellulose, hydroxyethyl cellulose, hydroxypropyl methylcellulose, maltodextrin and polymethacrylates, and most preferably selected from the group of polyvinyl alcohols, polyvinyl alcohol copolymers and hydroxypropyl methyl cellulose (HPMC), and combinations thereof. Preferably, the level of polymer in the pouch material, for example a PVA polymer, is at least 60%.

The polymer can preferably have any weight average molecular weight, more preferably from about 1000 to 1,000,000 g/mol, even more preferably from about 10,000 to 300,000 g/mol and still more preferably from about 20,000 to 150,000 g/mol.

By incorporating a polymer made from vinyl dicarboxylic acid monomers into the cleaning composition, the cleaning composition can include at least about 30.0 wt. % water and can be packed in a water-soluble unit dose article.

In an aspect, the presently claimed invention is directed to a kit comprising
(i) at least one additive of the general formula (I); and
(ii) at least one rinse surfactant which has a melting point in the range of 25° C. to 50° C. and cloud point in the range of 35° C. to 70° C., determined according to DIN EN 1890:1999.

The present invention offers one or more of following advantages:

1. The cleaning composition reduces the accumulation of fat residues in the parts of the pump and circulation protecting filter systems such as particle filters or sieves considerably.

2. The cleaning composition is hygienic as the bad odor due to accumulation of fat is minimized.

3. Minimized maintenance of the components of the dishwasher, leading to reduce in maintenance cost and increase in the life of the dishwasher.

In the following, specific embodiments of the present invention are described:

1. A method for reducing deposition of fat on a surface from a fat containing aqueous liquid wherein the fat containing aqueous liquid comprises a cleaning composition comprising
(i) at least one additive of the general formula (I)

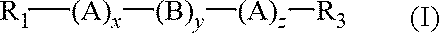

wherein
   R₁ is independently selected from linear or branched, substituted or unsubstituted C₁ to C₂₂ alkyl
   A is CH₂—CH₂—O
   B is CH₂—CHR₂—O, wherein R₂ is selected from H and linear or branched, unsubstituted C₁ to C₈ alkyl
   R₃ is selected from H and linear or branched, substituted or unsubstituted C₁ to C₂₂ alkyl
   x is an integer in the range of 1 to 100
   y is an integer in the range of 0 to 35
   z is an integer in the range of 0 to 35; and
(ii) at least one rinse surfactant which has a melting point in the range of 25° C. to 50° C. and cloud point in the range of 35° C. to 70° C., determined according to DIN EN 1890:1999.

2. The method according to embodiment 1, wherein (i) the at least one additive of the general formula (I) has a hydrophilic-lipophilic balance (HLB) value in the range of 10 to 19.

3. The method according to embodiment 1, wherein R₁ is selected from methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, n-heneicosyl, n-docosyl, isopropyl, isobutyl, isopentyl, isohexyl, isoheptyl, isooctyl, isononyl, isodecyl, isoundecyl, isododecyl, isotridecyl, isotetradecyl, isopentadecyl, isohexadecyl, isoheptadecyl, isooctadecyl, isononadecyl, isoeicosyl, isoheneicosyl, isodocosyl, 2-propyl heptyl, 2-ethyl hexyl and t-butyl.

4. The method according to embodiment 1, wherein R₃ is selected from H, methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, n-heneicosyl, n-docosyl, isopropyl, isobutyl, isopentyl, isohexyl, isoheptyl, isooctyl, isononyl, isodecyl, isoundecyl, isododecyl, isotridecyl, isotetradecyl, isopentadecyl, isohexadecyl, isoheptadecyl, isooctadecyl, isononadecyl, isoeicosyl, isoheneicosyl, isodocosyl, 2-propyl heptyl, 2-ethyl hexyl and t-butyl.

5. The method according to one or more of embodiments 1 to 4, wherein R₁ is selected from linear or branched, unsubstituted C₁-C₂₂ alkyl, x is an integer in the range of 2 to 100, y is 0, z is 0 and R₃ is H.

6. The method according to one or more of embodiments 1 to 5, wherein R₁ is selected from linear or branched, unsubstituted C₁₀-C₂₂ alkyl, x is an integer in the range of 5 to 90, y is 0, z is 0 and R₃ is H.

7. The method according to one or more embodiments 1 to 5, wherein the at least one rinse surfactant is a compound of general formula (II)

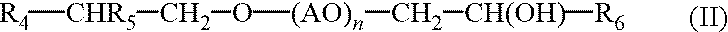

wherein
R₄ is selected from linear or branched, substituted or unsubstituted C₂-C₄-alkyl,
R₅ is an alkyl group bearing two carbon atoms more than R₄,
n is an integer in the range of 10 to 35,
AO is selected from identical or different, CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O, and CH₂—CH(C₂H₅)—O, and
R₆ is selected from linear or branched, substituted or unsubstituted C₆-C₁₈-alkyl.

8. The method according to embodiment 1, wherein the at least one rinse surfactant is a compound of general formula (III)

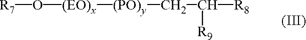

R₉ wherein
R₇ and R₈ is independently selected from linear or branched, substituted or unsubstituted C₈-C₂₀-alkyl,
R₉ is selected from H and OH,
EO is CH₂—CH₂—O,
PO is selected from CH(CH₃)—CH₂—O and CH₂—CH(CH₃)—O,
x is an integer in the range of 10 to 50, and
y is an integer in the range of 0 to 10.

9. The method for reducing deposition of fat on a surface from a fat containing aqueous liquid according to one or more of embodiments 1 to 8, wherein the fat containing aqueous liquid comprises a cleaning composition comprising
(i) at least one additive of the general formula (I)

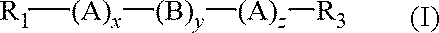

wherein
   R₁ is independently selected from linear or branched, substituted or unsubstituted C₁ to C₂₂ alkyl,
   A is CH₂—CH₂—O,
   B is CH₂—CHR₂—O, wherein R₂ is selected from H and linear or branched, unsubstituted C₁ to C₈ alkyl,
   R₃ is selected from H and linear or branched, substituted or unsubstituted C₁ to C₂₂ alkyl,
   x is an integer in the range of 1 to 100,
   y is an integer in the range of 0 to 35,
   z is an integer in the range of 0 to 35; and
(ii) at least one rinse surfactant wherein the at least one rinse surfactant is a compound of general formula (II)

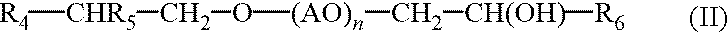

wherein
   R₄ is linear or branched, substituted or unsubstituted C₂-C₄-alkyl,
   R₅ is an alkyl group bearing two carbon atoms more than R₄,
   n is in the range of 10 to 35,
   AO is selected from identical or different, CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O, or CH₂—CH(C₂H₅)—O, and

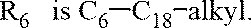

10. The method for reducing deposition of fat on a surface from a fat containing aqueous liquid according to one or more of embodiments 1 to 8, wherein the fat containing aqueous liquid comprises a cleaning composition comprising
(i) at least one additive of the general formula (I)

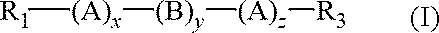

wherein
   R₁ is independently selected from linear or branched, substituted or unsubstituted C₁ to C₂₂ alkyl,
   A is CH₂—CH₂—O,
   B is CH₂—CHR₂—O, wherein R₂ is selected from H and linear or branched C₁ to C₈ alkyl,
   R₃ is selected from H and linear or branched, substituted or unsubstituted C₁ to C₂₂ alkyl,
   x is an integer in the range of 1 to 100,
   y is an integer in the range of 0 to 35,
   z is an integer in the range of 0 to 35; and
(ii) at least one rinse surfactant wherein the at least one rinse surfactant is a compound of general formula (III)

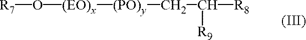

wherein
   R₇ and R₈ independently is linear or branched, substituted or unsubstituted C₈- C₂₀-alkyl,
   R₉ is H or OH,
   EO is CH₂—CH₂—O,
   PO is selected from CH(CH₃)—CH₂—O and CH₂—CH(CH₃)—O,
   x is in the range of 10 to 50, and
   y is in the range of 0 to 10

11. The method according to one or more of embodiments 1 to 10, wherein the molar ratio of (i) the at least one additive of the general formula (I), and (ii) the at least one rinse surfactant is in the range of 0.02:1 to 1:1.

12. The method according to one or more of embodiments 1 to 11, wherein the cleaning composition further comprises at least one adjunct component.

13. The method according to embodiment 12, wherein the at least one adjunct component is selected from chelating agents, enzymes, builders, cobuilders, alkali metal carriers, bleaching agents, bleach catalysts, bleach activators, dyes, perfumes, corrosion inhibitors, anti-redeposition agents and fillers.

14. The method according to one or more of embodiments 1 to 13, wherein the surface is a metal surface, plastic surface, glass surface, porcelain surface or ceramic surface.

15. The method according to embodiment 14, wherein the surface is located inside a dishwasher.

16. The method according to embodiment 15, wherein the surface is located inside a dishwasher and is in fluid connection with the dishwasher washing chamber.

17. The method according to embodiment 14, wherein the surface is facing the dishwasher washing chamber.

18. A method for reducing deposition of fat in a dishwasher from a fat containing aqueous liquid according to one or more of embodiments 1 to 13, wherein the fat containing aqueous liquid comprises a cleaning composition comprising
(i) at least one additive of the general formula (I)

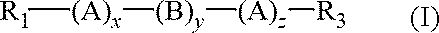

wherein
   R₁ independently is selected from linear or branched, substituted or unsubstituted C₁ to C₂₂ alkyl
   A is CH₂—CH₂—O
   B is CH₂—CHR₂—O, wherein R₂ is selected from H and linear or branched, unsubstituted C₁ to C₈ alkyl
   R₃ is selected from H and linear or branched, substituted or unsubstituted C₁ to C₂₂ alkyl
   x is an integer in the range of 1 to 100
   y is an integer in the range of 0 to 35
   z is an integer in the range of 0 to 35; and
(ii) at least one rinse surfactant which has a melting point in the range of 25° C. to 50° C. and cloud point in the range of 35° C. to 70° C., determined according to DIN EN 1890:1999.

19. The method according to one or more of embodiments 15 to 18, wherein the dishwasher is an automatic dishwasher.

20. The method for reducing deposition of fat in an automatic dishwasher from a fat containing aqueous liquid according to embodiment 19, comprising at least one or more of the steps selected from
(a) arranging the soiled dishware in the dishwasher,
(b) adding the cleaning composition according to one or more of embodiments 1 to 13 to the dosing chamber of the automatic dishwasher,
(c) selecting and initiating a wash program of the automatic dishwasher,
(d) obtaining during wash operation a fat containing aqueous liquid; and
(e) rinsing the dishware of step (d) in the final wash operation step.

21. The method according to embodiment 20, further comprising step (f) of drying the dishware.

22. Use of the cleaning composition according to one or more of embodiments 1 to 13 for reducing accumulation of fat on a surface.

23. Use of the cleaning composition according to one or more of embodiments 1 to 13 for reducing accumulation of fat, wherein the surface is a metal surface, plastic surface, glass surface, porcelain surface or ceramic surface.

24. The use according to embodiment 22 or 23, wherein the surface is located inside a dishwasher.

25. The use according to embodiment 24, wherein the surface is located inside the dishwasher and is in fluid connection with the dishwasher washing chamber.

26. The use according to embodiment 22 or 23, wherein the surface is part of the inner surface of the dishwasher washing chamber.

27. The use according to one or more of embodiments 22 to 26, wherein the cleaning composition is stored and/or employed for use in the form of powder, gel, tablet or liquid form.

28. The use according to one or more of embodiments 24 to 26, wherein the dishwasher is an automatic dishwasher.

29. A unit dose article comprising the cleaning composition according to one or more of embodiments 1 to 13.

30. The unit dose article according to embodiment 29 comprising single or multiple compartments.

31. The water-soluble unit dose article according to one or more of embodiments 29 or 30.

### EXAMPLES

### Compounds (A.1)

### Compounds of General Formula (II):

(I) n—C₅H₁₁—CH(n—C₃H₇)—CH₂—O—(EO)₂₁—CH₂—CH(OH)—n—C₁₀H₂₁
(II) n—C₅H₁₁—CH(n—C₃H₇)—CH₂—O—(EO)₂₃—CH₂—CH(OH)—n—C₁₀H₂₁

### Compounds of General Formula (III):

(III) iso—C₁₁H₂₃—O—(EO)₂₁—CH₂—CH(OH)—n—C₁₀H₂₁
(IV) iso—C₉H₁₉—O—(EO)₂₀—CH₂—CH(OH)—n—C₁₀H₂₁
(V) iso—C₁₃H₂₇—O—(EO)₂₆—CH₂—CH(OH)—n—C₁₀H₂₁
(VI) iso—C₁₁H₂₃—O—(EO)₂₂—CH₂—CH(OH)—n—C₈H₁₇
(VII) iso-C13 Alcohol + ca. 1 PO + 27 EO + C8C18-Fatty acid

### Compound (A.2)

### Compound of General Formula (III):

(I) fatty alcohol C8-C10 + 40EO + C12 Epoxide

### Additives of General Formula (I)

### Compounds (B.1)

(I) fatty alcohol C16-C18 + 80EO
(II) fatty alcohol C16-C18 + 25EO
(III) fatty alcohol C16-C18 + 50EO

### Comparative Examples

### Compounds (B.2)

(I) fatty alcohol C10-C12 + 6EO + 8PO
(II) iso-C13 + 7 (EO)

### Adjunct Components

Chelating agent 1: Trisodium salt of methyl glycinediacetic acid (MGDA—Na₃)
Chelating agent 2: Trisodium citrate dihydrate
Enzyme 1: Protease
Enzyme 2: Amylase
Builder 1: Polyacrylic acid M_{w} 4000 g/mol as sodium salt, completely neutralized.
Builder 2: Polycarboxylate polymer of 2-Acrylamido-2-methylpropane sulfonic acid and acrylic acid
Builder 3: Na₂Si₂O₅
Cobuilder: 1-hydroxyethane-1,1-diphosphonate (HEDP)
Bleaching agent: Sodium percarbonate
Filler: Sodium sulfate
Bleach activator: tetraacetylethylenediamine (TAED)
Alkali metal carrier: Na₂CO₃

### Clear Melting Points of Rinse Surfactants (Compounds of General Formula (II) and (III))

The clear melting points of the rinse surfactants A.1 and A.2 were measured with a Reichert-Jung microscope Type 302101, using a Reichert Jung heating system Type 651501 and heating plate V40W80 R6416 with a testoterm 7000 pT 100 temperature sensing device. while operating with polarized light. For the optical magnification to detect the clear melting point visually a Bausch & Lomb WF10x/18 binocular and 60/- objective was used in the microscope. Before measurement the samples were heated 15° C. above the estimated melting point and a drop of the sample was placed on a cover glass (VWR 18×18 mm No.1 ECN 631-1567), covered with a plastic cap and stored for 24 h at 23° C. The cover glass was placed on the heating plate and the heating system was started on lowest heat transfer rate. The sample was observed and the clear melting point in the display of the testoterm temperature sensing device noted once the test sample changed from nontransparent solid to clear liquid. The standard deviation of the clear melting point was± 0.5° C. The results are summarized in table 1.

TABLE 1

Clear Melting Points

| Compounds | Clear Melting Points [°C] |
|---|---|
| (A.1) (I) | 31.0 |
| (A.1) (II) | 30.5 |
| (A.1) (III) | 30.5 |
| (A.1) (IV) | 28.5 |
| (A.1) (V) | 30.0 |
| (A.1) (VI) | 33.0 |
| (A.1) (VII) | 32.0 |
| (A.2) (I) | 47.0 |

### Cloud Points of Rinse Surfactants (Compounds of General Formula (II) and (III))

The determination of cloud points was measured according to the test procedure described in DIN EN 1890:1999, 8.6 Method E : Solution in 25 g of BDG/water (Butyldiglycol/water solution). The results are summarized in table 2.

TABLE 2

Cloud points

| Compounds | Cloud points [°C] |
|---|---|
| (A.1) (I) | 48.5 |
| (A.1) (II) | 49.0 |
| (A.1) (III) | 43.0 |
| (A.1) (IV) | 37.0 |
| (A.1) (V) | 44.2 |
| (A.1) (VI) | 51.0 |
| (A.1) (VII) | 52.0 |
| (A.2) (I) | 67.5 |

### Surface Tension of Rinse Surfactants (Compounds of General Formula (II) and (III))

The surface tension was measured according to the test procedure described in EN 14370 with the plate method (4.2) at a concentration of 1.0 g/L in distilled water at 23° C. The values listed in table 3 were averaged values of 10 single measurements in one solution.

The results are summarized in table 3.

TABLE 3

Surface Tension

| Compounds | Surface tension [mN/m] |
|---|---|
| (A.1) (III) | 29.1 |
| (A.1) (I) | 28.6 |
| (A.1) (II) | 29.6 |
| (A.1) (IV) | 28.8 |
| (A.1) (V) | 30.2 |
| (A.1) (VI) | 29.0 |
| (A.1) (VII) | 31.0 |
| (A.2) (I) | 34.1 |
| (B.2) (I) | 30.4 |
| (B.1) (I) | 55.0 |
| (B.1) (II) | 42.0 |
| (B.1) (III) | 48.2 |
| (B.2) (II) | 26.9 |

### Preparation of the Automatic Dishwashing Compositions

The cleaning compositions for automatic dishwashing ADW.1 and ADW.2 according to table 4 were made by mixing the solid ingredients except (A.1), (A.2) and (B.1) and weighing portions of 17.1 g of this base mixture. To each portion the associated quantity found in the table of the examples of molten (A.1), (A.2) and (B.1) was added. (A.1), (A.2) and (B.1) was then distributed homogeneously in the mixture before adding into the dosing chamber of the dishwashing machine.

TABLE 4

| All amounts in g/sample | ADW.1 | ADW.2 |
|---|---|---|
| Chelating agent 1 | 40.0 | 10.0 |
| Enzyme 1 | 2.5 | 2.5 |
| Enzyme 2 | 1.0 | 1.0 |
| Compounds according to general formula (II) and (III), (A.1) | 3.0 to 5.0 | 3.0 to 5.0 |
| Compounds according to general formula (III) (A.2) | 0 to 1.0 | 0 to 1.0 |
| Compounds according to general formula(I) (B.1) | 0.1 to 2.0 | 0.1 to 2.0 |
| Builder 1 | 5.0 | 5.0 |
| Builder 2 | 0.0 | 0.0 |
| Bleaching agent | 15.0 | 10.2 |
| Filler | 1.0 | 0.0 |
| Bleach activator | 4.0 | 4.0 |
| Builder 3 | 2.0 | 2.0 |
| Alkali metal carrier | 23.7 | 24.5 |
| Chelating agent 2 | 0.0 | 35.0 |
| Cobuilder | 0.8 | 0.8 |

Cleaning compositions prepared according to Table-4 are excellent in reducing the accumulation of fat residues as well as in rinsing, especially when used as automatic dishwashing compositions.

### Example I

### Fat Residue

The determination of fat residues of example I was carried out in Miele automatic dish wash machines, type G 1223 SC GSL2. The program 45° C. (“R-time 2”, for washing) and 55° for rinsing was selected. No separate rinsing agent was added, no regenerating salt was used. The dish-wash experiments were carried out with water, 21°dH (German hardness), (Ca:Mg):HCO₃ (3:1):1.35.

In each experiment three stainless steel knives eight tea cups and nine dinner plates were placed in the dishwasher as base load. Before each cycle, 5 g of Biskin Gold®, a solid vegetable fat, and 5 g of margarine were added into the machine. For each cycle the detergent formulation according to table 5 were added to the machine, consisting of base mixture (Table 4) and (A.1) and (B.1). 5 cycles were run without drying times between cycles. After the 5^{th} cycles the filters from the bottom of the machines were taken out of the machine and dried for 18 h at ambient conditions. The weights of the filters were determined and the differences to their weights before the first cycle were calculated (fat residue [g] = weight of filter before test [g] - weight of filter after test). The standard deviation of the fat residue is± 0.2 g.

The results are summarized in table 5.

TABLE 5

Fat residue test

| Example no. | Formulation (ADW.2) | base mixture [g] | (A.1) [g] | (B.1) [g] | Fat residue [g] |
|---|---|---|---|---|---|
| Comparative example 1 | (A.1) (VI) | 17.10 | 0.90 | - | 4.67 |
| Inventive example 1 | (A.1) (VI) / (B.1) (I) | 17.10 | 0.90 | 0.045 | 2.82 |
| Inventive example 2 | (A.1) (VI) / (B.1) (I) | 17.10 | 0.90 | 0.090 | 2.10 |
| Inventive example 3 | (A.1) (VI) / (B.1) (I) | 17.10 | 0.90 | 0.135 | 0.86 |
| Inventive example 4 | (A.1) (VI) / (B.1) (I) | 17.10 | 0.90 | 0.180 | 0.40 |

As is evident from Table 5 above, for the comparative example 1 of the cleaning composition with only rinse surfactant there is high amount of fat residue, compared to the inventive cleaning compositions of examples 1 to 4 comprising both the rinse surfactant and additive where there is a significant reduction on the amount of fat residue.

### Example II

### Fat Residue

The determination of fat residues of example II was carried out in Miele automatic dish wash machines, type G 1223 SC GSL2. The program 45° C. (“R-time 2”, for washing) and 55° for rinsing was selected. No separate rinsing agent was added, no regenerating salt was used. The dish-wash experiments were carried out with water, 21°dH (German hardness), (Ca:Mg):HCO₃ (3:1):1.35.

In each experiment three stainless steel knives eight tea cups and nine dinner plates were placed in the dishwasher as base load. Before each cycle, 5 g of Biskin Gold®, a solid vegetable fat, and 5 g of margarine were added into the machine. For each cycle the detergent formulation according to table 6 were added to the machine, consisting of base mixture (Table 4) and (A.1), (A.2) and (B.1). 5 cycles were run without drying times between cycles. After the 5^{th} cycle the filters from the bottom of the machines were taken out of the machine and dried for 18 h at ambient conditions. The weights of the filters were determined and the differences to their weights before the first cycle were calculated (fat residue [g] = weight of filter before test [g] - weight of filter after test). The standard deviation of the fat residue is± 0.2 g.

The results are summarized in table 6.

TABLE 6

Fat residue test

| Example no. | Formulation (ADW.2) | base mixture [g] | (A.1) [g] | (A.2) [g] | (B.1) [g] | Fat residue [g] |
|---|---|---|---|---|---|---|
| Comparative example 2 | (A.1) (II) | 17.10 | 0.72 | - | - | 4.05 |
| Comparative example 3 | (A.1) (II) / (A.2) (I) | 17.10 | 0.72 | 0.18 | - | 5.29 |
| Inventive example 5 | (A.1) (II) / (A.2) (I) / (B.1) (II) | 17.10 | 0.72 | 0.18 | 0.045 | 3.04 |
| Inventive example 6 | (A.1) (II) / (A.2) (I) / (B.1) (I) | 17.10 | 0.72 | 0.18 | 0.090 | 0.69 |
| Inventive example 7 | (A.1) (II) / (A.2) (I) / (B.1) (I) | 17.10 | 0.72 | 0.18 | 0.135 | 0.78 |
| Inventive example 8 | (A.1) (II) / (A.2) (I) / (B.1) (I) | 17.10 | 0.72 | 0.18 | 0.180 | 1.29 |

As is evident from Table 6 above, for the comparative example 2 and 3 of the cleaning composition with only rinse surfactant there is high amount of fat residue, compared to the inventive cleaning compositions of examples 5 to 8 comprising both the rinse surfactant and additive where there is a significant reduction on the amount of fat residue.

### Example III

### Fat Residue

The determination of fat residues of example III was carried out in Miele automatic dish wash machines, type G 1223 SC GSL2. The program 45° C. (“R-time 2”, for washing) and 55° for rinsing was selected. No separate rinsing agent was added, no regenerating salt was used. The dish-wash experiments were carried out with water, 21°dH (German hardness), (Ca:Mg):HCO₃ (3:1):1.35.

In each experiment three stainless steel knives eight tea cups and nine dinner plates were placed in the dishwasher as base load. Before each cycle, 5 g of Biskin Gold®, a solid vegetable fat, and 5 g of margarine were added into the machine. For each cycle the detergent formulation according to table 7 were added to the machine, consisting of base mixture (Table 4) and (A.1) and (B.1). 5 cycles were run without drying times between cycles. After the 5^{th} cycle the filters from the bottom of the machines were taken out of the machine and dried for 18 h at ambient conditions. The weights of the filters were determined and the differences to their weights before the first cycle were calculated (fat residue [g] = weight of filter before test [g] - weight of filter after test). The standard deviation of the fat residue is± 0.2 g.

The results are summarized in table 7.

TABLE 7

Fat residue test

| Example no. | Formulation (ADW.1) | base mixture [g] | (A.1) [g] | (B.1) [g] | Fat residue [g] |
|---|---|---|---|---|---|
| Comparative example 4 | (A.1) (II) | 17.10 | 0.900 | - | 6.09 |
| Inventive example 9 | (A.1) (II) / (B.1) (I) | 17.10 | 0.810 | 0.090 | 3.05 |
| Inventive example 10 | (A.1) (II) / (B.1) (I) | 17.10 | 0.788 | 0.112 | 1.86 |
| Inventive example 11 | (A.1) (II) / (B.2) (II) | 17.10 | 0.900 | 0.810 | 5.39 |
| Inventive example 12 | (A.1) (VII) / (B.1) (I) | 17.10 | 0.900 | 0.810 | 4.19 |

As is evident from Table 7 above, for the comparative example 4 of the cleaning composition with only rinse surfactant there is high amount of fat residue, compared to the inventive cleaning compositions of examples 9 to 12 comprising both the rinse surfactant and additive where there is a significant reduction on the amount of fat residue.

### Example IV

### Rinsing Experiments:

The rinsing experiments of example IV were carried out in Miele automatic dish wash machines, type G1223 GSL2. The program 45° C. (“R-time 2”, for washing) and 55° for rinsing was selected. No separate rinsing agent was added, no regenerating salt was used. The dish-wash experiments were carried out with water, 21°dH (German hardness), (Ca:Mg):HCO₃ (3:1):1.35. In each experiment eight tea cups and nine dinner plates were placed in the dishwasher as base load. For evaluation in each experiment three knives (stainless steel), three blue melamine resin plates, three drinking glasses and three plates from china were placed in the dishwasher. Before each cycle 100 g of soil, comprising fat, protein and starch in the form of margarine, egg-yolk and starch, were added. For each cycle the detergent formulation according to table 8 were added to the machine, consisting of base mixture and (A.1), (A.2) and (B.1).

In each cycle, 18 g of the detergent compositions for automatic dishwashing ADW.1 and ADW.2 according to table 8 were added into the dosing chamber of the machine.

Between two cycles, a waiting period of one hour was hold, of which 10 minutes were with the door of the dishwashing machine closed and 50 minutes with open door. The dishes for the evaluation were checked by visual assessment of the ware after 6 cycles in a darkened chamber under light behind an aperture diaphragm was awarded using a grading scale from 1 (very poor) to 10 (very good). The grades for each type of table ware (knives (stainless steel), blue melamine resin plates, drinking glasses, plates from china) were summed up and divided by the number (3) of tableware. Results are found in table 8. Σ Spotting is the sum of the values for all 4 different tableware types. The standard deviation of the grades in the comparative test is ± 0.5.

The results are summarized in table 8.

TABLE 8

rinse performance

| Example no. | Formula tion (ADW.2) | base mixtu re [g] | (A.1) [g] | (A.2) [g] | (B.1) [g] | Spotti ng, knives | Spott ing, glass | Spott ing, mela mine | Spotti ng, china | Σ Spott ing |
|---|---|---|---|---|---|---|---|---|---|---|
| Comparative example 5 | (A.1) (II) | 17.10 | 0.9 | - | - | 10.0 | 10.0 | 6.3 | 10.0 | 36.3 |
| Inventive example 13 | (A.1) (II) / (A.2) (I) | 17.10 | 0.9 | 0.18 | 0.045 | 10.0 | 8.3 | 3.7 | 9.0 | 31.0 |
| Inventive example 14 | (A.1) (II) / (A.2) (I) / (B.1) (I) | 17.10 | 0.9 | 0.18 | 0.050 | 10.0 | 10.0 | 4.0 | 7.0 | 31.0 |
| Inventive example 15 | (A.1) (II) / (A.2) (I) / (B.1) (I) | 17.10 | 0.9 | 0.18 | 0.065 | 10.0 | 6.0 | 4.7 | 7.0 | 27.7 |

The inventive examples 13 to 15, comprising both the additive and rinse surfactant display an improved rinse performance as is evident from the lower spotting value on a wide variety of material, compared to the comparative example 5, which does not contain the rinse surfactant.

### Example V

### Oil Separation Test

For the test of the oil separation, a beaker of 1000 mL (high form) is filled with 500 mL of a 60° C. tempered water, 21°dH (German hardness), (Ca:Mg):HCO₃ (3:1):1.35. The formulation (ADW.2) is added to a concentration of 3.6 g/L and additives (A.1) and (B.1) are added in the amount listed in table 9. The added substances are then dissolved homogenously by gentle stirring to prepare the test solution. 5 g of a oily soil, tempered at 60° C. and consisting of 2.5 g of Biskin Gold®, a solid vegetable fat is then added to the test liquid. The test liquid with the oily soil is then stirred with a propeller mixer (three wings) using a IKA RW-20 stirring device at a stirring speed of 1000 rpm for 5 minutes. During the stirring the propeller of the stirring device is placed on the level of the 250 mL mark of the beaker. Afterwards the liquid is transferred to a 500 mL measuring flask with an extended and graduated bottleneck, having the capacity to hold the full amount of the test liquid and allowing the volumetric analysis of phase separated oily phase on top of the transferred liquid. The volume of separated oil phase is recorded after 30 min. The standard deviation of the fat residue is± 0.1 mL.

The results are summarized in table 9.

TABLE 9

Oil Separation Test

| Example no. | Formulation (ADW.1) | base mixture [g/L] | (A.1) [ppm] | (B.1) [ppm] | Oil separation [mL] |
|---|---|---|---|---|---|
| Comparative example 6 | without compounds | 3.6 | 0 | 0 | 0.2 |
| Comparative example 7 | (A.1) (II) | 3.6 | 36 | 0 | 0.7 |
| Inventive example 16 | (A.1) (II) / (B.1) (I) | 3.6 | 36 | 9 | 0.4 |
| Comparative example 8 | (A.1) (VI) | 3.6 | 36 | 0 | 0.7 |
| Inventive example 17 | (A.1) (VI) / (B.1) (I) | 3.6 | 36 | 9 | 0.4 |

In Table-9, the inventive examples 16 and 17 comprising both the additive and rinse surfactant show a low oil separation value compared to the comparative examples 7 and 8 without the rinse surfactant. A reduced oil separation will lead to easy pumping of the fat-water mixture generated during wash, which is desired for a composition to reduce accumulation of residual fat on a surface.

### Comparative Example I: Use of Rinse Surfactant Different From the Inventive Rinse Surfactant

The determination of fat residues of comparative example I was carried out in Miele automatic dish wash machines, type G 1223 SC GSL2. The program 45° C. (“R-time 2”, for washing) and 55° for rinsing was selected. No separate rinsing agent was added, no regenerating salt was used. The dish-wash experiments were carried out with water, 21°dH (German hardness), (Ca:Mg):HCO₃ (3:1):1.35.

In each experiment three stainless steel knives eight tea cups and nine dinner plates were placed in the dishwasher as base load. Before each cycle, 5 g of Biskin Gold®, a solid vegetable fat, and 5 g of margarine were added into the machine. For each cycle the detergent formulation according to table 4 were added to the machine, consisting of base mixture and (A.1) and (B.2). 5 cycles were run without drying times between cycles. After the 5^{th} cycles the filters from the bottom of the machines were taken out of the machine and dried for 18 h at ambient conditions. The weights of the filters were determined and the differences to their weights before the first cycle were calculated (fat residue [g] = weight of filter before test [g] - weight of filter after test). The standard deviation of the fat residue is± 0.2 g.

The results are summarized in table 10.

TABLE 10

Fat residue test

| Example no. | Formulation (ADW.2) | base mixture [g] | (A.1) [g] | (B.2) [g] | Fat residue [g] |
|---|---|---|---|---|---|
| Comparative example 9 | (A.1) (VI) | 17.10 | 0.90 | - | 4.67 |
| Comparative example 10 | (A.1) (VI) / (B.2) (I) | 17.10 | 0.81 | 0.09 | 5.42 |

As is seen in Table 10, use of compound B.2, rinse surfactant different from that of the presently claimed invention, leads to a higher amount of fat residue.

1. A method for reducing deposition of fat on a surface from a fat containing aqueous liquid wherein the fat containing aqueous liquid comprises a cleaning composition comprising
(i) at least one additive of general formula (I) 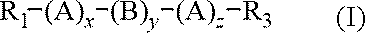
wherein
R₁ is independently selected from the group consisting of linear or branched, substituted or unsubstituted C₁₀ to C₂₂ alkyl,
A is CH2—CH2—O,
B is CH₂—CHR₂—O, wherein R₂ is selected from the group consisting of H and linear or branched, unsubstituted C₁ to C₈ alkyl,
R₃ is selected from the group consisting of H and linear or branched, substituted or unsubstituted C₄ to C₂₂ alkyl,
x is an integer in a range of 5 to 90,
y is an integer in a range of 0 to 35, and
z is an integer in a range of 0 to 35; and
(ii) at least one rinse surfactant which has a melting point in a range of 25° C. to 50° C. and a cloud point in a range of 35° C. to 70° C., determined according to DIN EN 1890:1999, wherein the at least one rinse surfactant is a compound of general formula (II) or (III) 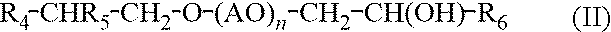
wherein
R₄ is selected from the group consisting of linear or branched, substituted or unsubstituted C₂-C₄-alkyl,
R₅ is an alkyl group bearing two carbon atoms more than R₄,
n is an integer in a range of 10 to 35,
AO is selected from the group consisting of identical or different, CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O, and CH₂—CH(C₂H₅)—O, and
R6 is selected from the group consisting of linear or branched, substituted or unsubstituted C6-C18-alkyl; 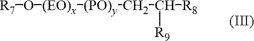
wherein
R₇ and R₈ are independently selected from the group consisting of linear or branched, substituted or unsubstituted C₈-C₂₀-alkyl,
R₉ is selected from the group consisting of H and OH,
EO is CH₂—CH₂—O,
PO is selected from the group consisting of CH(CH₃)—CH₂—O and CH₂—CH(CH₃)—O,
x is an integer in a range of 10 to 50, and
y is an integer in a range of 0 to 10.

2. The method according to claim 1, wherein R₁ is selected from the group consisting of linear or branched, unsubstituted C₁₀-C₂₂ alkyl, x is an integer in a range of 5 to 90, y is 0, z is 0 and R₃ is H.

3. The method according to claim 1, wherein a molar ratio of (i) the at least one additive of the general formula (I), and (ii) the at least one rinse surfactant is in a range of 0.02:1 to 1:1.

4. The method according to claim 1, wherein the cleaning composition further comprises at least one adjunct component selected from the group consisting of chelating agents, enzymes, builders, cobuilders, alkali metal carriers, bleaching agents, bleach catalysts, bleach activators, dyes, perfumes, corrosion inhibitors, anti-redeposition agents and fillers.

5. A method of using the cleaning composition according to claim 1, the method comprising using the cleaning composition for reducing accumulation of fat on a surface.

6. The method according to claim 5, wherein the cleaning composition is stored and/or employed for use in a form of powder, gel, tablet or liquid form.

7. The method according to claim 1, wherein the surface is a metal surface, a plastic surface, a glass surface, a porcelain surface or a ceramic surface.

8. The method according to claim 1, wherein the surface is located inside a dishwasher and is part of an inner surface of a washing chamber of the dishwasher.

9. The method according to claim 1, wherein the surface is located inside a dishwasher and is in fluid connection with a washing chamber of the dishwasher.

10. The method according to claim 1, wherein the surface is located inside a dishwasher, and wherein the dishwasher is an automatic dishwasher.

11. A method for reducing deposition of fat in an automatic dishwasher from a fat containing aqueous liquid, comprising at least one or more steps selected from
(a) arranging soiled dishware in the automatic dishwasher,
(b) adding the cleaning composition according to claim 1 to a dosing chamber of the automatic dishwasher,
(c) selecting and initiating a wash program of the automatic dishwasher,
(d) obtaining, during wash operation, a fat containing aqueous liquid; and
(e) rinsing the dishware of step (d) in a final wash operation step.

12. A unit dose article comprising the cleaning composition according to claim 1.

13. The unit dose article according to claim 12, wherein the unit dose article is water-soluble.

14. The method according to claim 5, wherein the surface is a metal surface, a plastic surface, a glass surface, a porcelain surface or a ceramic surface.

15. The method according to claim 5, wherein the surface is located inside a dishwasher and is part of an inner surface of a washing chamber of the dishwasher.

16. The method according to claim 5, wherein the surface is located inside a dishwasher and is in fluid connection with a washing chamber of the dishwasher.

17. The method according to claim 5, wherein the surface is located inside a dishwasher, and wherein the dishwasher is an automatic dishwasher.
